(19) United States
(12) Patent Application Publication
(10) Pub. No.: US 2017/0176654 A1
(43) Pub. Date: Jun. 22, 2017

(54) MIRROR WITH STRESS-COMPENSATED REFLECTIVE COATING

(71) Applicant: Corning Incorporated, Corning, NY (US)

(72) Inventors: Kent S. Sawyer, Jaffrey, NH (US); Leonard Gerard Wamboldt, Sunderland, MA (US)

(21) Appl. No.: 15/369,947

(22) Filed: Dec. 6, 2016

Related U.S. Application Data
(60) Provisional application No. 62/268,711, filed on Dec. 17, 2015.

(51) Int. Cl. G02B 5/08; G02B 7/182

(52) U.S. Cl. CPC G02B 5/085; G02B 7/182

(57) ABSTRACT

A low stress reflective optic is provided. The reflective optic includes a substrate, a spectral thin-film stack, and a stress-compensation thin-film stack. The stress-compensation stack is positioned between the spectral stack and the substrate and is designed to include internal stresses that offset or counteract internal stresses present in the spectral stack. Reduced stresses in the spectral stack lead to a reduction or elimination of surface distortions of the optic. Reflective optics with superior performance characteristics are achieved.

This application claims the benefit of priority under 35 U.S.C. §119 of U.S. Provisional Application Ser. No. 62/268,711 filed on Dec. 17, 2015 the content of which is relied upon and incorporated herein by reference in its entirety.

### FIELD

This description pertains to reflective optics. More particularly, this description pertains to mirrors with a reflective coating. Most particularly, this description pertains to mirrors with a stress-compensated reflective coating.

### BACKGROUND

Reflective optics are critical components of surveillance systems in many aerospace and defense applications. The explosive growth in the utilization of unmanned air vehicles with sophisticated surveillance systems has increased the demand for versatile, lightweight reflective optics. Since the performance of a reflective optic depends primarily on the characteristics of the surface, the typical strategy for reducing the weight of reflective optics is to reduce the thickness of the substrate. Thinning of the substrate, however, leads to an increase in the aspect ratio of the reflective optic. The desire for reflective optics with ever larger surface area leads to a need for additional increases in aspect ratio.

Large aspect ratios are problematic for reflective optics because the condition of the surface becomes more sensitive to residual stresses in the substrate. Residual internal stresses frequently develop in the substrate during the processes used to manufacture or machine the substrate material. As the substrate gets thinner, the substrate is less able to support residual internal stresses and the stresses relax. Relaxation of residual internal stress within the substrate leads to distortions in the shape of the surface, and optical coatings disposed on the surface, that diminish optical performance.

Coatings are another source of stress in reflective optics. Materials used for coatings differ from the substrate material and result in mismatches in lattice constant and thermal expansion characteristics that can cause residual stresses to develop in the coating. Coating materials are often formed on the substrate as thin film using elevated (high) temperature deposition methods. Differences in the coefficient of thermal expansion coefficient of the coating and the substrate create thermal stresses in the coating upon cooling of the coating from the deposition temperature. Coating stresses can also result from the microstructure of the coating and processing conditions used to form the coating. Densification of coatings, for example, may be desired and may be effected by plasma-assisted or ion bombardment techniques. Exposure of the coating to plasma or energetic ions can create stresses in the coating. The presence of stresses in the coating can lead to distortions in the shape of the surface of the coating. If the substrate is sufficiently thick, the substrate is less susceptible to deformation and can inhibit distortion in the coating surface caused by internal coating stresses. As the substrate is thinned in an effort to achieve lightweight reflective optics, however, it is less able to inhibit distortions in the surface of coatings and optical performance is compromised.

Several strategies for preventing or alleviating internal stresses in coatings have been proposed. In one strategy, coating stresses are offset by stresses in the substrate. In this strategy, if the coating stress is predictable, the surface of the substrate can be designed (shaped, cut, or otherwise configured) to include an offsetting stress to counteract the coating stress. If the coating, for example, adds two waves of positive power to an optic having an unmodified substrate, the unmodified substrate can be modified by machining to include two waves of negative power. The resulting optic has a net power difference of zero and preserves the optical power of the unmodified substrate. This strategy is difficult to implement, however, because it can be difficult to predict the coating stress, especially in optics with complex geometries. Modifying the substrate to include a compensating stress may also present practical challenges from a fabrication perspective.

A second strategy involves adding a supplemental coating on the side of the substrate opposite the reflective coating. Depositing the same coating on opposite sides of the substrates provides coatings with stresses that counteract each other to prevent surface distortions. Implementation of this strategy is often difficult, however, because of differences in geometry of the front and back surfaces of the substrate. The back surface of the substrate, for example, often needs to be adapted or shaped to accommodate mounting hardware and/or is often modified by removing material in a non-uniform manner to lightweight the substrate.

A third strategy is to adapt the deposition process used to form the coating to provide coatings, or layers within coatings, to have low internal stresses. Although it is often possible to form coatings, or layers within coatings, having low internal stresses, the reduction in stress is often accompanied by structural relaxations in the individual layers that alter the structure of the coating in a manner that impairs optical performance. One mechanism, for example, for reducing stress is to form coatings with high porosity. Porous coatings have lower stress than dense coatings, but are less preferred from a performance standpoint because they usually provide inferior optical properties (e.g. reflectivity in the near-UV and visible spectral ranges is often diminished and scattering is often enhanced in porous coatings; absorption increases in water-related bands (e.g. at 2.9 μm) often adversely affect chemical and mechanical properties). Efforts to reduce stresses in individual layers may also induce structural changes in the layers that produce voids or other defects that compromise optical performance or compatibility with adjacent layers in the coating.

There exists a need for low stress or stress-free reflective optics. In particular, there is a need for minimizing distortions in reflective coatings caused by residual stresses in the substrate and/or within the reflective coating itself.

### SUMMARY

A low stress reflective optic is provided. The reflective optic includes a substrate, a spectral thin-film stack, and a stress-compensation thin-film stack. The stress-compensation stack is positioned between the spectral stack and the substrate and is designed to include internal stresses that offset or counteract internal stresses present in the spectral stack. Reduced stresses in the spectral stack lead to a reduction or elimination of surface distortions of the optic. Reflective optics with superior performance characteristics are achieved.

The present description extends to

A mirror comprising:
a substrate;
a reflective stack, said reflective stack having a first stress-thickness factor; and
a stress-compensation stack, said stress-compensation stack having a second stress-thickness factor, said second stress-thickness factor opposing said first stress-thickness factor.

The present description extends to:

A method of making a mirror comprising:
forming a stress-compensation stack on a substrate; and forming a spectral stack on said stress-compensation stack

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 depicts a reflective optic having a stress-compensation stack and a reflective stack.

FIG. 2 depicts a spectral stack that includes a reflective layer, an adhesion layer, a tuning layer, and a protective layer.

FIG. 3 shows a surface profilometer measurement of a crystalline Si(100) substrate.

FIG. 4 shows a surface profilometer measurement of a layer of YbOₓF_{y} on a crystalline Si(100) substrate.

FIG. 5 shows a surface profilometer measurement of a crystalline Si(100) substrate.

FIG. 6 shows a surface profilometer measurement of a layer of Nb₂O₅ on a crystalline Si(100) substrate.

FIG. 7 shows a reflective optic with a spectral stack on a crystalline Si(100) substrate.

FIG. 8 shows a reflective optic with a stress-compensation stack and a spectral stack on a crystalline Si(100) substrate.

FIG. 9 shows a reflective optic with a stress-compensation stack and a spectral stack on a crystalline Si(100) substrate.

FIG. 10 shows a reflective optic with a stress-compensation stack and a spectral stack on a crystalline Si(100) substrate.

FIG. 11 shows the surface of an uncoated substrate in top view and oblique view.

FIG. 12 shows the surface of a substrate with a reflective coating in top view and oblique view.

FIG. 13 shows the surface of an uncoated substrate in top view and oblique view.

FIG. 14 shows the surface of a substrate with a reflective coating in top view and oblique view.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and/or C are disclosed as well as a class of substituents D, E, and/or F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but do touch an intervening material or series of intervening materials, where the intervening material or at least one of the series of intervening materials touches the other. Elements in contact may be rigidly or non-rigidly joined. Contacting refers to placing two elements in direct or indirect contact. Elements in direct (indirect) contact may be said to directly (indirectly) contact each other.

As used herein, “directly adjacent” means in direct contact with, where direct contact refers to a touching relationship. Elements that are separated by one or more intervening regions or layers are referred to herein as being “indirectly adjacent” and are in indirect contact with each other. The term “adjacent” encompasses elements that are directly or indirectly adjacent to each other.

Reference will now be made in detail to illustrative embodiments of the present description.

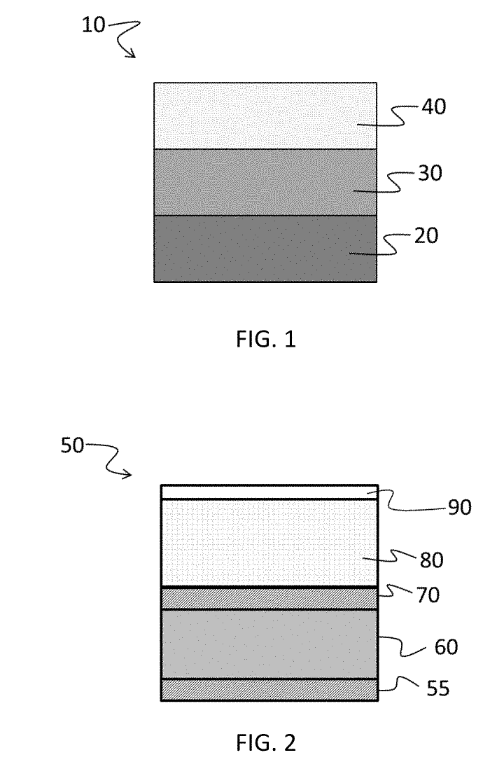

The present description provides a reflective optic with a reduced-stress reflective coating. The reduced-stress reflective coating is a multilayer thin film structure that includes a spectral stack and a stress-compensation stack. The spectral stack includes one or more layers, at least one of which is a reflective layer. The stress-compensation stack includes one or more layers and is designed to offset or counteract stress that would be present in the spectral stack in the absence of the stress-compensation stack. A schematic depiction of a reflective optic having a reflective coating and stress-compensation stack is shown in FIG. 1. Reflective optic 10 includes substrate 20. Stress-compensation stack 30 is in contact with substrate 20 and spectral stack 40 is in contact with stress-compensation stack 30. In the embodiment shown in FIG. 1, stress-compensation stack 30 is in direct contact with substrate 20 and spectral stack 40 is in direct contact with stress-compensation stack 30. Spectral stack 40 is in indirect contact with substrate 20. In other embodiments, additional layers (e.g. barrier layers, corrosion-resistant layers, adhesion layers, abrasion enhancement layers etc.) may be disposed between substrate 20 and stress-compensation stack 30 and/or between stress-compensating stack 30 and spectral stack 40.

A variety of materials can be used as the substrate for the reduced-stress reflective coating. Representative substrate materials include Al, alloys of Al (e.g. T6061 Al), Mg, alloys of Mg, Si, carbon, graphite, dielectrics, metal oxides, SiO₂, ceramics, and glass. For light weight optics, thin substrates are preferred. Typical substrate thicknesses are in the range from 100 nm 10 mm, or in the range from 200 nm-5 mm, or in the range from 300 nm-3 mm, or in the range from 400 nm-2 mm, or in the range from 500 nm-1 mm.

The spectral stack includes a reflective layer and optionally includes one or more adhesion layer(s), tuning layer(s) and protective layer(s). An illustrative spectral stack is depicted in FIG. 2. Spectral stack 50 includes interface layers 55 and 70, reflective layer(s) 60, tuning layer(s) 80, and protective layer(s) 90.

Interface layers may improve adhesion or galvanic compatibility between layers of the spectral stack or between the spectral stack and the stress-compensation stack. In one embodiment, an interface layer is directly adjacent to a reflective layer and a tuning layer. In another embodiment, an interface layer is directly adjacent a reflective layer and a layer of the stress-compensation stack. Representative interface layers include one or more of Ni, Cr, Ni—Cr alloys (e.g. Nichrome), Ni—Cu alloys (e.g. Monel), Ti, TiO₂, ZnS, Pt, Ta₂O₅, Nb₂O₅, Al₂O₃, AlN, AlOₓN_{y}, ITO (In₂O₃:Sn), Bi, Bi₂O₃. Si₃N₄, SiO₂, SiOₓN_{y}, DLC (diamond-like carbon), MgF₂, YbF₃, and YF₃. The interface layer is selected on the basis of compatibility with the reflective layer. The interface layer may have a thickness in the range from 0.2 nm to 25 nm, where the lower end of the thickness range (e.g. 0.2 nm to 2.5 nm, or 0.2 nm to 5 nm) is more appropriate when the interface layer is a metal (to prevent parasitic absorbance of light) and the higher end of the thickness range (e.g. 2.5 nm to 25 nm, or 5 nm to 25 nm) is more appropriate when the interface layer is a dielectric.

The spectral stack includes one or more reflective layers. The reflective layer(s) preferably provide high reflectivity in one or more of the ultraviolet (UV), near ultraviolet (NUV), visible (VIS), near infrared (NIR), shortwave infrared (SWIR), midwave infrared (MWIR), and long wave infrared (LWIR) bands. The reflective layer(s) include metals or metal alloys. Silver (Ag) is a preferred reflective layer because it exhibits high reflectivity over a wide wavelength range, low polarization splitting, and low emissivity. Other reflective layers are elemental or alloy materials that include one or more elements selected from the group consisting of Ag, Au, Al, Rh, Cu, Pt and Ni. The thickness of the reflective layer (or combination of two or more reflective layers) may be in the range from 25 nm-500 nm, or in the range from 50 nm 400 nm, or in the range from 75 nm-300 nm, or in the range from 100 nm-250 nm. The reflective layer may be directly adjacent one or more interface layers, or directly adjacent a layer of the stress-compensation stack, or directly adjacent a tuning layer, or directly adjacent a protective layer.

The spectral stack includes one or more tuning layers. The one or more tuning layers may be positioned directly adjacent a reflective layer or directly adjacent an interface layer or directly adjacent a protective layer. Tuning layer(s) are designed to optimize reflection in defined wavelength regions. Tuning layer(s) typically include an alternating combination of high and low refractive index materials, or high, intermediate, and low refractive index materials. Materials used for tuning layers are preferably low absorbing in the wavelength range of from 0.4 μm to 15.0 μm. Dielectric oxides and fluorides are preferred materials for tuning layers. Representative materials for tuning layers include YbF₃, GdF₃, YF₃, YbOₓF_{y}, GdF₃, Nb₂O₅, Bi₂O₃, HfO₂, SiO₂, TiO₂, Si₃N₄, AlF₃, MgF₂, Ta₂O₅, and ZnS. The tuning layer(s) (individually or in combination) may have a thickness in the range of 75 nm to 300 nm. In one embodiment, the spectral stack includes YbF₃ and ZnS as tuning layers. In another embodiment, the spectral stack includes YbOₓF_{y} and Nb₂O₅ as tuning layers.

The protective layer provides resistance to scratches, resistance to mechanical damage, and chemical durability. Representative materials for the protective layer include YbF₃, YbFₓO_{y}, YF₃, SiO₂, ZrO₂, and Si₃N₄. The protective layer(s) is the top layer of the reflective coating. The protective layer(s) may be selected to not interfere with the performance of tuning layer(s) or to augment the performance of the tuning layer(s). The protective layer(s) may have a thickness in the range of 60 nm to 200 nm.

The spectral stack may also include one or more barrier layer(s) (not shown in FIG. 2). A barrier layer may be positioned between the spectral stack and the stress-compensation stack and may act to prevent contamination of the spectral stack with impurities or elements originating from the stress-compensation stack. A barrier layer may also be positioned between the stress-compensation stack and the substrate and may act to insure galvanic compatibility between the stress-compensation stack and the substrate. The barrier layer(s) may also act to protect the substrate from corrosion by sealing the substrate or blocking corrosive agents from contacting the substrate. The barrier layer(s) may also protect the substrate from abrasion. Representative barrier layers include Si₃N₄, SiO₂, TiAlN, TiAlSiN, TiO₂, DLC (diamond-like carbon), Al, CrN, and SiₓN_{y}O_{z}. The barrier layer(s) may have a thickness in the range from 100 nm to 50 μm, or in the range from 500 nm to 10 μm, or in the range from 1 μm to 5 μm.

The stress-compensation stack may also compensate for stresses in a barrier layer or a combination of a barrier layer and a spectral stack. In one embodiment, a stress-compensation stack is between a barrier layer and a spectral stack and acts to counteract stress in either or both of the barrier layer and spectral stack. In another embodiment, the barrier layer is omitted and a stress-compensation stack is designed to include layers that improve the resistance of the substrate to corrosion and abrasion.

The stress-compensation stack includes one or more layers and is designed to manifest a stress that counteracts or offsets stress present in the spectral stack to provide a reduced-stress reflective coating. In one non-limiting model, and without wishing to be bound by theory, the principle of stress compensation encompasses a balancing, approximate balancing, or counteraction of the stress-thickness factor of the spectral stack with the stress-thickness factor of the stress-compensation stack. The stress-thickness factor S of a layer is given by Eq. (1):

S=σt Eq. (1)

where σ is the mean residual stress of the layer and t is the thickness of the layer. The stress thickness factor of a stack consisting of multiple layers is given by Eq. (2)

$$S = {\sum }_{i = 1}^{n} {S}_{i} = {\sum }_{i = 1}^{n} {σ}_{i} {t}_{i} \qquad Eq . ( 2 )$$

where i indexes the layers in the stack, n is the number of layers in the stack, a, is the stress of the i^{th} layer of the stack, and tᵢ is the thickness of the i^{th} layer of the stack.

The condition of balancing the stress-thickness factor of the spectral stack (Sₛ) and the stress-thickness factor of the stress-compensation stack (S_{c}) is given by Eq. (3)

S_{c}=−Sₛ Eq. (3)

where the negative sign accounts for opposing nature of the stress in the stress-compensation stack relative to the stress in the spectral stack. For purposes of the present description, tensile stress is regarded as a positive stress and compressive stress is regarded as a negative stress. If, for example, the stress of the spectral stack is tensile, the stress of the stress-compensating stack is designed to be compressive. Similarly, if the stress of the spectral stack is compressive, the stress of the stress-compensation stack is tensile. This relationship of stresses between the spectral stack and stress-compensation stack may be referred to herein as an opposing stress relationship; that is, the stress in the stress-compensation stack may be said to oppose the stress in the spectral stack. The opposing tensile-compressive stress relationship of the stress-compensation stack relative to the spectral stack leads to compensation of stresses in the spectral stack by stresses in the stress-compensation stack. Inclusion of the negative sign in Eq. (3) means that under the condition of stress balancing, the magnitude of the tensile (compressive) stress of the stress-compensation stack balances (through the stress-thickness factor) the magnitude of the compressive (tensile) stress of the spectral stack.

The tensile vs. compressive nature of stress in a layer may be referred to herein as the state of stress or stress state of the layer. A layer in tension manifests a tensile stress and is in a state of tension or tensile state. A layer in compression manifests a compressive stress and is in a state of compression or compressive state. Similarly, a stack in tension manifests a net tensile stress and is in a net state of tension or net tensile state. A stack in compression manifests a net compressive stress and is in a net state of compression or net compressive state. A stress-thickness factor having a positive sign may be referred to as tensile and a stress-thickness factor having a negative sign may be referred to as compressive. Opposing stress-thickness factors have opposite sign and reflect opposite signs for the stress in layers or net stresses in stacks.

The present description extends beyond the rigorous balancing of the stress-thickness factors indicated by strict adherence to Eq. (3) to include approximate balancing of the stress-thickness factors or any relationship between stress-thickness factors in which the stress σ_{c} in the stress-compensation stack is opposite in sign to the stress σₛ of the spectral stack so that at least partial compensation of stresses in the spectral stack occurs upon inclusion of the stress-compensating stack in the reflective coating. Embodiments include reflective coatings that include any combination of spectral stack(s) and stress-compensation stack(s) that have opposing stresses.

The magnitude of the stress-thickness factor of the stress-compensation stack may be within ±40% of the magnitude of the stress-compensation factor of the spectral stack, or the magnitude of the stress-thickness factor of the stress-compensation stack may be within ±30% of the magnitude of the stress-thickness factor of the spectral stack, or the magnitude of the stress-compensation stack may be within ±20% of the magnitude of the stress-compensation factor of the spectral stack, or the magnitude of the stress-thickness factor of the stress-compensation stack may be within ±10% of the magnitude of the stress-thickness factor of the spectral stack, the magnitude of the stress-compensation stack may be within ±5% of the magnitude of the stress-compensation factor of the spectral stack, or the magnitude of the stress-thickness factor of the stress-compensation stack may be within ±3% of the magnitude of the stress-thickness factor of the spectral stack.

The stress α of a layer on a substrate can be calculated or estimated from equations known by those of skill in the art of solid phase mechanics. In the case of a thin film having a circular cross-section, for example, the stress σ can calculated from the form of Stoney's equation shown as Eq. (4):

$$σ = \frac{1}{6} ( \frac{1}{{R}_{post}} - \frac{1}{{R}_{pre}} ) ( \frac{1}{1 - {v}_{s}} ) {E}_{s} ( \frac{{t}_{s}^{2}}{{t}_{f}} ) \qquad Eq . ( 4 )$$

where tₛ is the substrate thickness, νₛ is the Poisson's ratio of the substrate, Eₛ is the Young's modulus of the substrate, Rₚᵣₑ is the radius of curvature of the substrate before applying the coating, Rₚₒₛₜ is the radius of curvature of the substrate after applying the coating. In a typical application of Eq. (4) (or corresponding equations for other geometries), νₛ and Eₛ are known material properties of the substrate, and t_{f}, Rₚₒₛₜ, and Rₚᵣₑ are measured.

Stresses and thicknesses for individual layers within the spectral stack and stress-compensation stack can be determined and used to provide a stress-thickness factor for each layer. The stress-thickness factors for individual layers can be combined to obtain stress-thickness factors for the spectral stack and the stress-compensation stack. Within the context of the non-limiting model used herein, stresses for individual layers are determined separately in a configuration in which each layer is formed directly on the substrate as a sole layer in the absence of other layers. The stress of the layer in a stack is assumed to match the stress of the layer determined in this configuration. While not wishing to be bound by theory, it is believed that the non-limiting model described herein is an accurate or approximate estimate of the stresses in sole layers, individual layers within stacks, and net stresses of stacks. In actual practice, the estimates can be tested and the compositions and/or thicknesses of layers in a stack can be adjusted or finely tuned to meet product specifications or performance targets.

Although the stress of the stress-compensation stack as a whole opposes the stress of the spectral stack as a whole, individual layers within either the stress-compensation stack or spectral stack may have stresses that oppose each other. Either or both of the stress-compensation stack and spectral stack may include layers in tension and layers in compression. Layers in tension manifest a tensile stress and layers in compression manifest a compressive stress. When referring to the stress or stress-thickness factor of a stack herein, it is understood that net stress or net stress-thickness factor for the combination of layers in the stack is intended. Incorporation of layers within the stress-compensation stack having opposing stresses, for example, permits fine tuning and precise adjustment of the stress-thickness factor of the stress-compensation stack to provide closer matching to the stress-thickness factor of the spectral stack. In one embodiment, the stress-compensation stack includes two layers with opposing stress. In another embodiment, the stress-compensation stack includes three or more layers in which directly adjacent layers have opposing stresses (e.g. tensile-compressive-tensile- . . . or compressive-tensile-compressive- . . . ). In multilayer stacks, layers having the same stress state (tensile or compressive) may be the same or different materials.

The stress-compensation stack may include one or more layers of various materials. Representative materials include metal oxides, metal fluorides, metal oxyfluorides, and metal nitrides, such as Nb₂O₅, Yb₂O₃, Al₂O₃, YbF₃, YbFₓO_{y}, RE₂O₃, REF₃ (e.g. LaF₃, GdF₃) REOₓF_{y}, SiNₓ, Si₃N₄, CrN, SiOₓN_{y}, TM₂O₃, TMO₂, TM₂O₅, TMF₃, AlF₃, MgF₂, and TMOₓF_{y}, where RE refers to a rare earth ion and TM refers to a transition metal ion. Metals such as Ni, Al, alloys of Al, Bi, Sn, Mg, and alloys of Mg may also be included in the stress-compensation stack. In one embodiment, the stress-compensation stack includes a metal and a material having a low coefficient of thermal expansion (e.g. SiO₂). The stress-compensation stack may include, for example, a sequence of layers with a metal layer positioned between dielectric layers (e.g. SiO₂, where the stress-compensation stack includes the sequence of layers: SiO₂/Metal/SiO₂). The metal layer may have a larger coefficient of thermal expansion than the dielectric layer. Inclusion of a dielectric layer in the stress-compensation stack may alleviate or prevent problems related to galvanic incompatibility of the stress-compensation stack with the substrate or spectral stack.

The magnitude of stress and whether a layer is in tension or compression depends on the substrate. Factors such as the relative lattice constants, crystallographic structures, and thermal expansion coefficients of the layer and substrate influence the magnitude of stress and whether the stress in a layer is tensile or compressive on a particular substrate. Pure metals are tensile on most substrates.

In one embodiment, the stress-compensation stack includes a layer of YbOₓF_{y}. In another embodiment, the stress-compensation stack includes a layer of Nb₂O₅. In another embodiment, the stress-compensation stack includes a layer of YbOₓFy and a layer of Nb₂O₅. In still another embodiment, the stress-compensation stack includes an alternating sequence of layers of YbOₓF_{y} and Nb₂O₅.

In addition to providing compensation of stress in the spectral stack and/or barrier layer, the stress-compensation stack may also protect the substrate from corrosion. In one embodiment, a barrier layer is directly adjacent a substrate, a stress-compensation stack is directly adjacent the barrier layer, and a spectral stack is directly adjacent the stress-compensation stack. In this embodiment, either or both of the barrier layer and stress-compensation stack may inhibit corrosion of the substrate. In another embodiment, a stress-compensation stack is directly adjacent a substrate and a spectral stack is directly adjacent the stress-compensation stack. In this embodiment, the stress-compensation stack may inhibit corrosion of the substrate.

Fabrication of the reflective optic includes forming a stress-compensation stack on a substrate, forming a spectral stack on the stress-compensation stack, and optionally forming interface layer(s), barrier layer(s), and protective layer(s).

The layers of the stress-compensation stack, the layers of the spectral stack, barrier layer(s), interface layer(s), and protective layer(s) may be deposited by sputtering, physical vapor deposition, evaporation, plasma ion assisted deposition, or chemical vapor deposition. An exemplary low pressure magnetron sputtering process is described in U.S. Pat. No. 5,525,199, the disclosure of which is incorporated by reference herein. Chamber “over” pumping along with source and gas tooling configurations enable the low pressure sputtering, and allow the deposition of dense reactive and non-reactive films. Co-sputtering, for example of Mg and Al, or sputtering from an aluminum alloyed target of defined composition, can be used to enhance CTE matching with Al or Al-alloy substrates. The low pressure magnetron sputtering process can also be used to form of nitride, oxide, or oxynitride compounds of Al and other elements to provide interface and/or barrier layers. The density of the film can be influenced through deposition rate, ion bombardment of the surface, or exposure of the surface to a plasma. Slow deposition rates provide denser, more defect-free layers. The deposition rate of the layers may be less than 10 Å/sec, or less than 5 Å/sec, or less than 2 Å/sec. In-situ smoothing of the layers is achievable through ion bombardment or exposure to a plasma.

Once a specific composition for a layer has been identified, a sputtering target of the composition (or a combination of sputtering targets encompassing the elements of the composition) is (are) fabricated and used to sputter the desired coating. Since the substrate surface influences the morphology of the layers, it may be desirable to treat the substrate surface to make it is as smooth and defect-free as possible. High angle ion bombardment at the substrate surface can also be used to optimize morphology.

One or more of the layers may optionally be densified during deposition to minimize defects. Densification techniques include ion or plasma bombardment during deposition, minimization of high angle deposition from the sputtering target (e.g. via source masking), or inclusion of one or more densification layers in the stack of layers formed on the substrate. The densification technique may also smooth the layers. Ion or plasma bombardment may utilize ions or plasmas formed from an inert gas (e.g. Ar, Kr, He). In one embodiment, ion bombardment of the surface during deposition utilizes an average Ar ion beam density of 0.5 to 1 mA/cm² and average Ar ion energy of 30 eV to 60 eV.

Fabrication of the reflective optic may also include treatment of the substrate surface before depositing a material thereon. Treatment of the substrate surface may clean the substrate surface, remove defects or impurities, and/or smooth the substrate surface. Treatment of the substrate surface may include heating the substrate surface, polishing the substrate surface, exposing the substrate surface to a plasma or an ion beam, or diamond turning. In one embodiment, treatment of the substrate surface includes heating for 1-2 hours at 80-110° C. In another embodiment, treatment of the substrate surface includes ion bombardment for 15-30 minutes. The substrate surface may be smoothed by diamond turning. Polishing may occur after diamond turning the substrate and before heating or ion bombardment of the substrate.

### Illustrative Examples

Representative examples that illustrate selected aspects of the present description are now described. The examples include illustrations of the determination of the magnitude and state of stress in individual layers and stacks of individual layers. Applications to mirrors are also discussed.

Single layers of various materials were deposited on separate crystalline Si(100) substrates having a 100 mm diameter, 0.5 mm thickness, a Poisson's ratio of 0.26, and a Young's modulus of 130 GPa. The curvature of each substrate was measured before and after deposition of the layer using a Bruker Dektak 150 stylus profilometer. The stress σ for each layer was determined from the measured curvatures using Eq. (5). The thickness of each layer was also measured using a Bruker Dektak 150 stylus profilometer.

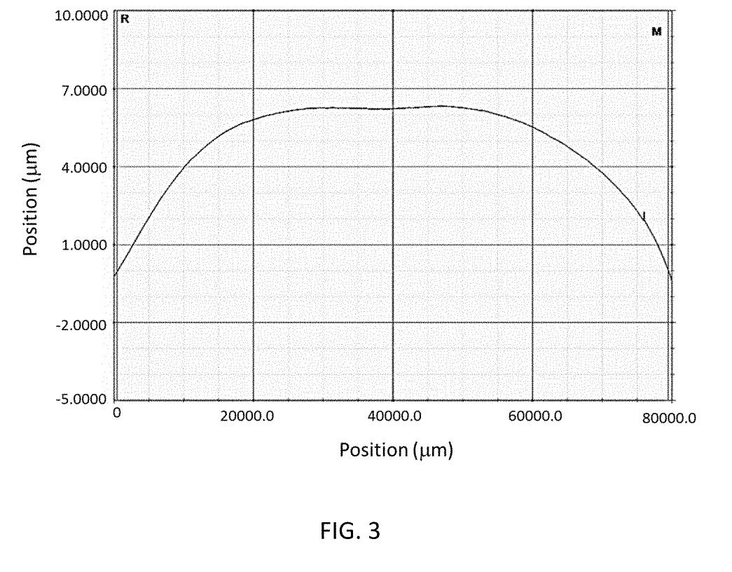

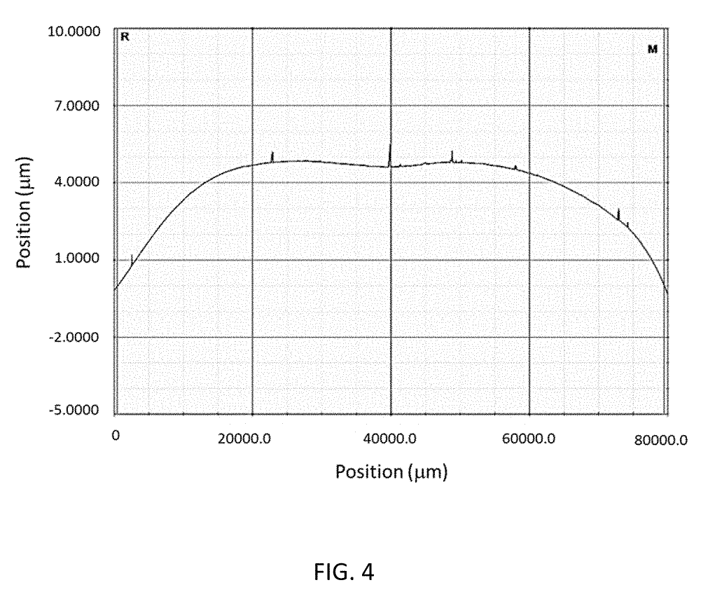

FIGS. 3 and 4, respectively, show measurement of the surface of a Si substrate (100 mm diameter) before and after deposition of a 128 nm thick coating of a YbOₓF_{y} thin film layer. The YbOₓF_{y} layer was deposited by IAD e-beam evaporation and covered the entire surface of the substrate. The profilometer plots shown in FIGS. 3 and 4 show surface height as a function of lateral position on the substrate. A region having a diameter of 80 mm was scanned. The curvatures Rₚᵣₑ and Rₚₒₛₜ were derived from the profilometer data. The stress α for the YbOₓF_{y} film was determined to be tensile and had a magnitude of 145 MPa.

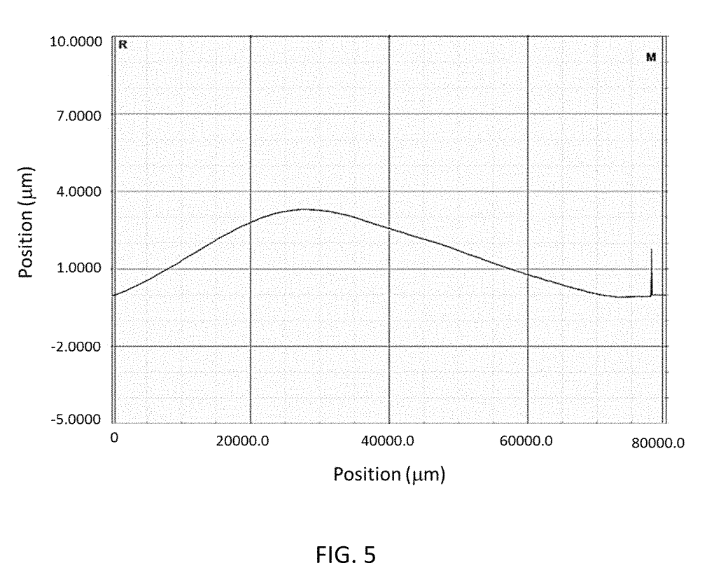

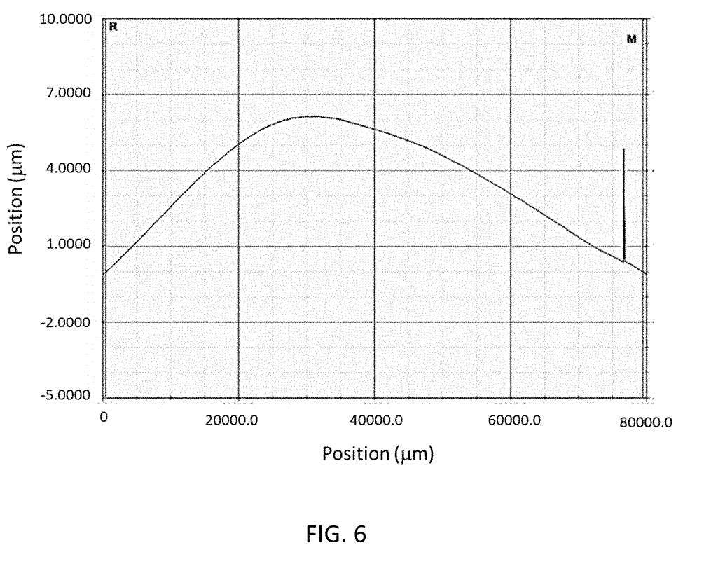

FIGS. 5 and 6, respectively, show measurement of the surface of a Si substrate before and after deposition of a 114 nm thick coating of Nb₂O₅ thin film layer. The curvatures Rₚᵣₑ and Rₚₒₛₜ were derived from the profilometer data. The stress σ for the Nb₂O₅ film was determined to be compressive and had a magnitude of 351 MPa.

Similar measurements were performed for layers of Si₃N₄, SiOₓN_{y}, Al₂O₃, and Ag. Table 1 lists magnitude and state of stress for the materials on the crystalline Si(100) substrates. The measured stress for Ag was within the margin of error of the measurement technique and is not reported in Table 1.

TABLE 1
Layer Stress on Si(100) Substrate

| Layer | Thickness | Stress Magnitude | | Stress State |
|---|---|---|---|---|
| Si₃N₄ | 300 nm | 2600 | MPa | compressive |
| SiOₓN_{y} | 210 nm | 220 | MPa | compressive |
| Al₂O₃ | 150 nm | 45 | MPa | compressive |
| CrN | 100 nm | 300 | MPa | compressive |

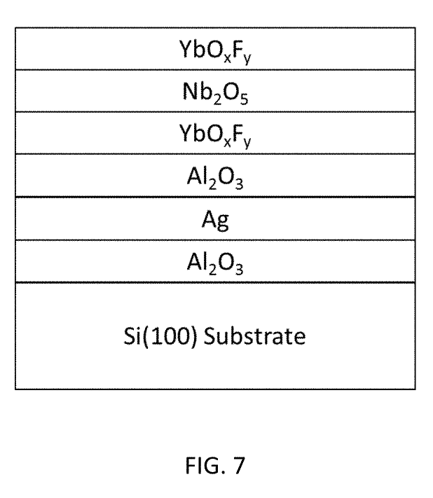

FIG. 7 shows a reflective optic with a spectral stack on a crystalline Si(100) substrate. The crystalline Si(100) substrate has a diameter of 100 mm and a thickness of 0.5 mm as indicated above. The spectral stack includes Ag as a reflective layer, two Al₂O₃ interface layers on opposing sides of the Ag reflective layer, and a series of tuning layers (two YbOₓF_{y} layers and a Nb₂O₅ layer). The stress and stress-thickness factor (Sₛ) for the spectral stack can be modeled using the stresses derived from the data shown in FIGS. 3-6 and the data shown in Table 1. The results, including thicknesses of the layers in the spectral stack, are summarized in Table 2, where the layers are ordered as shown in FIG. 7.

TABLE 2
Stress Characteristics of a Spectral Stack

| Layer | Thickness (μm) | Stress (MPa) | Sₛ (MPa-μm) |
|---|---|---|---|
| YbOₓFy | 0.070 | 145 | 10.15 |
| Nb₂O₅ | 0.015 | −351 | −5.27 |
| YbOₓF_{y} | 0.065 | 145 | 9.43 |
| Al₂O₃ | 0.050 | 45 | 2.25 |
| Ag | 0.120 | ~0 | ~0 |
| Al₂O₃ | 0.075 | 45 | 3.38 |
| Total | 0.395 | — | 19.94 |

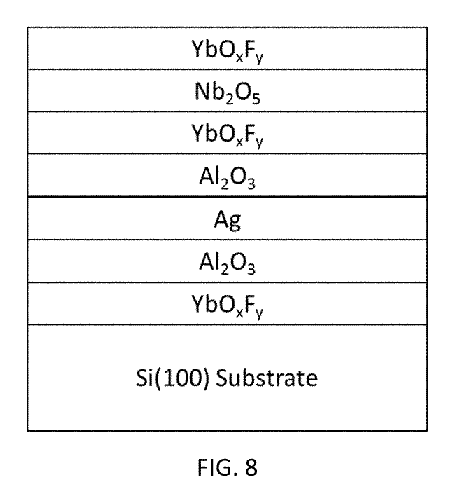

The results shown in Table 2 indicate that the net stress of the spectral stack is compressive and that the stress-thickness factor S has a value of 19.94 MPa-μm. To compensate for the stress in the spectral stack, a stress-compensation stack having a counteracting (tensile) stress-thickness factor may be included in the reflective optic. FIG. 8 illustrates a reflective optic with the substrate and spectral stack of FIG. 7 that further includes a stress-compensation stack consisting of a single layer of YbOₓF_{y}. As noted above, the stress σ in a layer of YbOₓF_{y} is tensile with a magnitude of 145 MPa. The stress-thickness factor of the layer of YbOₓF_{y} is the product of −145 MPa and the thickness of the YbOₓF_{y} layer. By designing the thickness of the YbOₓF_{y} layer to be 0.1375 μm, the stress-thickness factor of the YbOₓF_{y} layer becomes −19.94 MPa-μm and balances the stress-thickness factor of the spectral stack.

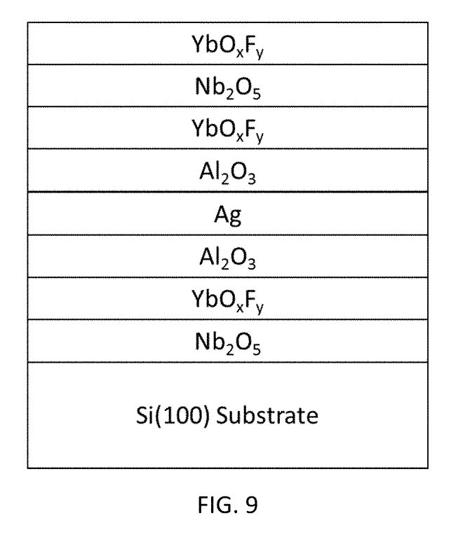

FIG. 9 shows an example in which the reflective optic shown in FIG. 7 further includes a stress-compensation stack that includes a layer of Nb₂O₅ and a layer of YbOₓF_{y}. The layers of Nb₂O₅ and a layer of YbOₓF_{y} have opposing stresses. Inclusion of multiple layers in the stress-compensation stack may provide better resistance of the substrate to corrosion or abrasion and may also provide better conformality or adhesion to the substrate. From the measurements above, the stress σ of a layer of Nb₂O₅ is 351 MPa and the stress σ of a layer of YbOₓF_{y} is −145 MPa. The stress-thickness factor S_{c} of the two-layer stress-compensation stack is given by Eq. (5):

S_{c}=351 MPa*t_{Nb}_{₂}_{O}_{₅}−145 MPa*t_{YbO}_{ₓ}_{F}_{_{y}} Eq. (5)

where t_{Nb2O5} is the thickness of the Nb₂O₅ layer and t_{YboxFy} is the thickness of the YbOₓF_{y} layer. Various combinations of thicknesses for the Nb₂O₅ and YbOₓF_{y} layers can provide a value of the stress-thickness factor S_{c} that counteracts or offsets the value of the stress-thickness factor Sₛ of the spectral stack. Rigorous balancing of stress-thickness factors occurs when S_{c}=−19.94 MPa-μm. This value of S_{c} can be obtained, for example, when the thickness of the Nb₂O₅ layer is 0.040 μm and the thickness of the YbOₓF_{y} layer is 0.234 μm. Numerous other combinations of the thicknesses of the Nb₂O₅ and YbOₓF_{y} layers are possible.

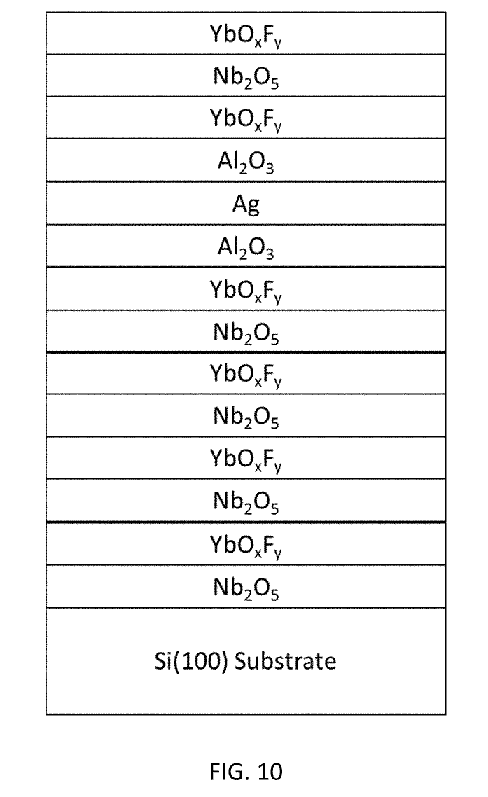

FIG. 10 shows an example in which the reflective optic shown in FIG. 7 further includes a stress-compensation stack that includes four periods of a dual-layer structure that includes a layer of Nb₂O₅ and a layer of YbOₓF_{y}. The stress-compensation stack includes 8 layers and has a stress-thickness factor S_{c} given by Eq. (7)

$${S}_{c} = {\sum }_{i = 1}^{8} {S}_{{c}_{i}} = {\sum }_{i = 1}^{8} {σ}_{i} {t}_{i} \qquad Eq . ( 7 )$$

where i indexes the layers in the stack, 8 is the number of layers in the stress-compensation stack, S_{ci} is the stress-thickness factor of the i^{th} layer of the stress-compensation stack, σᵢ is the stress of the i^{th} layer of the stress-compensation stack, and tᵢ is the thickness of the i^{th} layer of the stress-compensation stack. The thicknesses of the different Nb₂O₅ layers may be the same or different. The thicknesses of the different YbOₓF_{y} layers may be the same or different. Multiple combinations of layer thicknesses yield a compensating value S_{c}=−19.94 that offsets the stress-thickness factor of the spectral stack. In one example, all layers of Nb₂O₅ have a thickness of 0.010 μm and all layers of YbOₓF_{y} have a thickness of 0.059 μm.

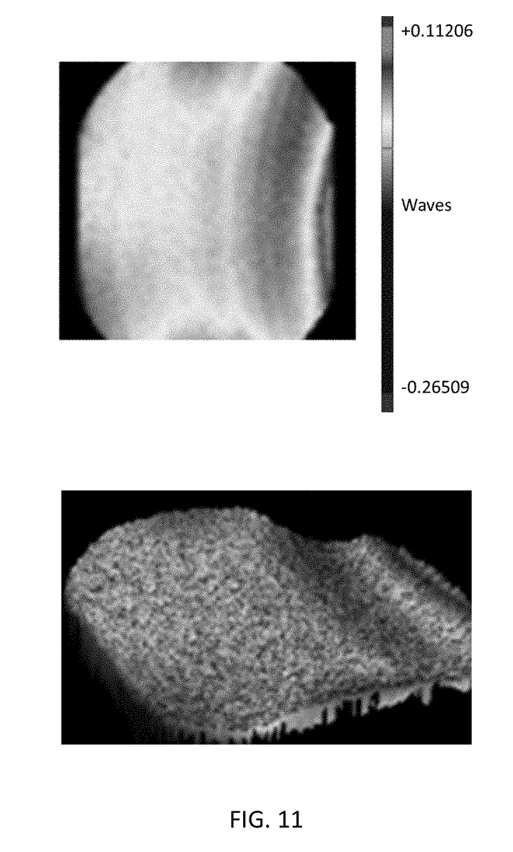

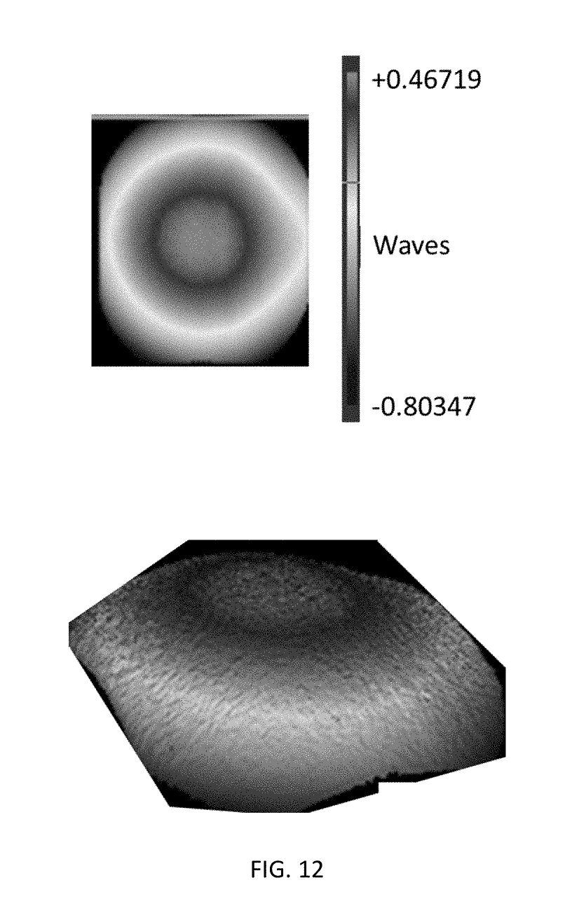

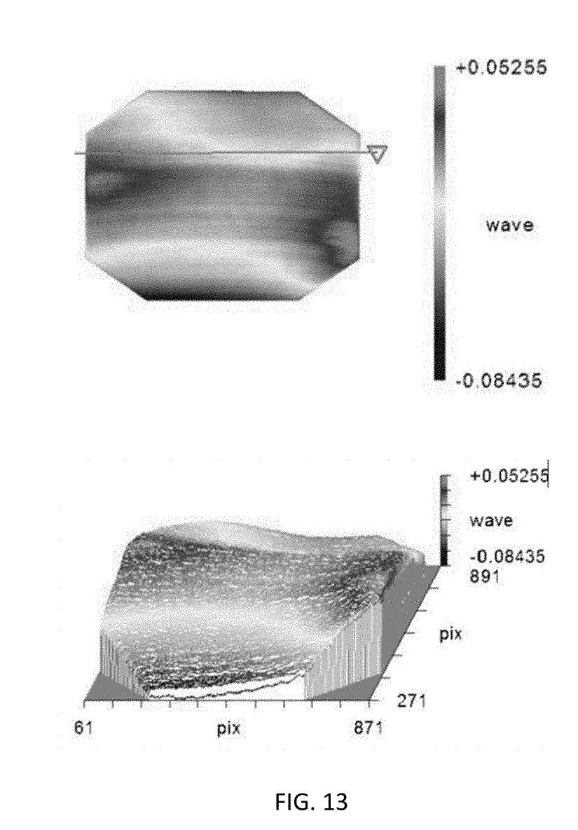

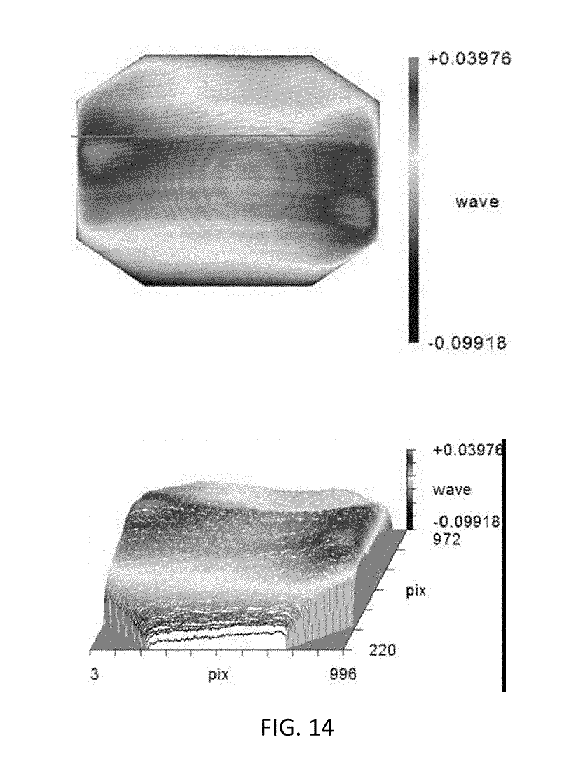

FIGS. 11-14 show surface figure measurements of two mirror samples. Surface figure is shown for substrates with (FIGS. 12 and 14) and without (FIGS. 11 and 13) reflective coatings. Surface figure was measured with a Zygo Verifie™ XPZ interferometer. The interferometer was set-up using a 1/20^{th} wave, 4-inch Dynaflect transmission flat and was operated with MetroPro 9 software. The measured system analysis (MSA) resulting in an RMS (root-mean-square) standard deviation of 0.002 waves for 10 individual measurements, each consisting of three phase averages. The standard error was 0.0006 waves RMS. The measurement configuration included no filters, no error subtractions, removal of piston and tile, and full surface measurements with no masks.

FIGS. 11 and 12 illustrate distortion of the surface figure of a representative mirror sample. The mirror consisted of a reflective coating that included a spectral stack directly adjacent the substrate without a stress-compensation stack. The substrate was crystalline Si(100) with a thickness of 0.5 mm and an aspect ratio of >13:1. The spectral stack included (in ascending order away from the surface of the substrate) layers of Si₃N₄/Al₂O₃/Ag/Al₂O₃/YbOₓF_{y}/Nb₂O₅/YbOₓF_{y}.

FIG. 11 shows images of the surface of the substrate before application of the reflective coating. The upper image is a top view and the lower image is an oblique view. Analysis of the data indicates that the surface figure of the substrate without the reflective coating was 0.754 fringes (peak-to-valley) or 0.054 fringes (RMS), and that the power of the surface was 0.036 fringes.

FIG. 12 shows images of the surface of the substrate after application of the reflective coating. The upper image is a top view and the lower image is an oblique view. Analysis of the data indicates that the surface figure of the substrate with the reflective coating was 2.541 fringes (peak-to-valley) or 0.578 fringes (RMS), and that the power of the surface was −2.379 fringes. The results from FIG. 13 indicate that deposition of a reflective coating on the surface of the mirror causes significant distortions occur in the figure and power of the mirror.

FIGS. 13 and 14 illustrate the beneficial effect of including a stress-compensation stack on the distortion of the surface figure of a representative mirror sample. The mirror consisted of a reflective coating that included a stress-compensation stack directly adjacent the substrate and a spectral stack directly adjacent the spectral stack. The substrate was crystalline Si(100) having a thickness of 0. 5 mm and an aspect ratio of >15:1. The stress-compensation stack included (in ascending order away from the surface of the substrate) layers of Nb₂O₅/YbOₓF_{y}/Nb₂O₅/YbOₓF_{y}/Nb₂O₅/YbOₓF_{y}/Nb₂O₅/YbOₓF_{y}/Nb₂O₅. The spectral stack included (in ascending order away from the surface of the stress-compensation stack) layers of Al₂O₃/Ag/Al₂O₃/YbOₓF_{y}/Nb₂O₅/YbOₓF_{y}.

FIG. 13 shows images of the surface of the substrate before application of the reflective coating. The upper image is a top view and the lower image is an oblique view. Analysis of the data indicates that the surface figure of the substrate without the reflective coating was 0.137 waves (peak-to-valley) or 0.022 waves (RMS), and that the power of the surface was −0.005 waves.

FIG. 14 shows images of the surface of the substrate after application of the reflective coating. The upper image is a top view and the lower image is an oblique view. Analysis of the data indicates that the surface figure of the substrate with the reflective coating was 0.139 waves (peak-to-valley) or 0.019 waves (RMS), and that the power of the surface was −0.009 waves. The results from FIG. 15 indicate that inclusion of a stress-compensation stack in the reflective coating essentially counteracts the distortions in surface figure and power that would otherwise result from the spectral stack. The surface figure and power of the mirror are nearly the same for the substrate with the reflective coating and the substrate without the reflective coating.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A mirror comprising:
a substrate;
a reflective stack, said reflective stack having a first stress-thickness factor; and
a stress-compensation stack, said stress-compensation stack having a second stress-thickness factor, said second stress-thickness factor opposing said first stress-thickness factor.

2. The mirror of claim 1, wherein said substrate is Al or an alloy of Al.

3. The mirror of claim 1, wherein said reflective stack includes two or more layers.

4. The mirror of claim 3, wherein said two or more layers include a reflective layer and an interface layer.

5. The mirror of claim 4, wherein said two or more layers further include a tuning layer.

6. The mirror of claim 4, wherein said reflective layer comprises Ag.

7. The mirror of claim 1, wherein said stress-compensation stack comprises a transition metal oxide.

8. The mirror of claim 1, wherein said stress-compensation stack comprises a rare earth oxide.

9. The mirror of claim 1, wherein said stress-compensation stack comprises an oxyfluoride compound.

10. The mirror of claim 1, wherein said stress-compensation stack comprises two or more layers.

11. The mirror of claim 10, wherein said two or more layers include a first layer comprising an oxide compound and a second layer comprising an oxyfluoride compound.

12. The mirror of claim 11, wherein said oxide compound is a transition metal oxide compound and said oxyfluoride compound is a rare earth oxyfluoride compound.

13. The mirror of claim 10, wherein said two or more layers include a first layer in tension and a second layer in compression.

14. The mirror of claim 13, wherein said first layer comprises an oxyfluoride compound.

15. The mirror of claim 13, wherein said first layer is in direct contact with said second layer.

16. The mirror of claim 13, wherein said two or more layers further include a third layer in tension and a fourth layer in compression.

17. The mirror of claim 16, wherein said first layer is in direct contact with said second layer and said fourth layer.

18. The mirror of claim 10, wherein said two or more layers include a layer of Nb₂O₅ and a layer of YbOₓF_{y}.

19. The mirror of claim 1, wherein said first stress-thickness factor is compressive and said second stress-thickness factor is tensile.

20. The mirror of claim 1, wherein said first stress-thickness factor has a first magnitude and said second stress-thickness factor has a second magnitude and wherein said second magnitude is within ±20% of said first magnitude.

21. The mirror of claim 20, wherein said second magnitude is within ±5% of said first magnitude.

22. The mirror of claim 1, wherein said stress-compensation stack is in direct contact with said substrate.

23. The mirror of claim 1, wherein said spectral stack is in direct contact with said stress-compensation stack.

24. A method of making a mirror comprising:
forming a stress-compensation stack on a substrate; and
forming a spectral stack on said stress-compensation stack.
